(19) United States
(12) Patent Application Publication
(10) Pub. No.: US 2009/0277102 A1
(43) Pub. Date: Nov. 12, 2009

(54) Contiguous inverted shelf kick flash apparatus

(76) Inventors: John Bishop, Vancouver, WA (US); Jeff Steffl, Vancouver, WA (US)

Correspondence Address: RYLANDER & ASSOCIATES PC, 406 West 12th Street, Vancouver, WA, 98660, US

(21) Appl. No.: 12/151,468

(22) Filed: May 6, 2008

(51) Int. Cl. E04D 3/38; B23P 17/00

(52) U.S. Cl. 52/58; 29/418

(57) ABSTRACT

An contiguous inverted shelf kick flashing apparatus is provided and includes a sheet of metal folded at a first angle along a bend joint to form a first sheet face and a second sheet face, and an inverted shelf bent inward at an second angle from the bend joint at a point of shelf inversion, along an inverted shelf edge, having a first and second triangular faces at an third angle to each other. A contiguous inverted shelf kick flash apparatus, including a sheet of metal flashing including a first and second opposing edges, a first bend extending through a portion of said sheet from a first point on said first edge to a break point, said break point located along a straight line between said first point and a second point along said second edge, wherein said first bend defines first and second flange faces and an interior angle between said first and second flange faces, and a second bend in opposing orientation to said first bend, said second bend extending from said break point to said second point on said second edge, said second bend forming an inverted corner diverter.

### FIELD OF THE INVENTION

The present invention relates kick flashing apparatus which redirects roof wash into the roof gutters.

### BACKGROUND

Kick flashing is used to divert rain water from a roof in a gutter. Most all water intrusion experts recommend kick flashing at the roof/gutter to wall transition area. Kick flashing can be used in a number of applications on the roof, such as dormers, skylights, fireplaces, where water needs to be diverted. However, the ideal location is at the roof to wall transition and where the end of the gutter is up against the wall or siding. When kick flashing is installed, any rain water traveling down the step flashing is diverted from the wall out into the gutter. When no kick flashing is installed, water traveling down the step flashing tends to travel behind the gutter end cap, not into the gutter, potentially traveling behind the siding and entering the wall cavity causing either mold issues which are known to cause respiratory problems, or can lead to rot, causing structural concerns.

Most if not all kick flashing used in the field is hand cut from standard step flashing and hand bent on site. This results in non-uniform, inconsistent, non attractive, in many cases ineffective and even potentially damaging.

The following represents a list of known related art:

| | | Date of |
|---|---|---|
| Reference: | Issued to: | Issue/Publication: |
| U.S. Pub. App. 2005/0183345 | Allen | Aug. 25, 2005 |
| U.S. Pub. App. 2003/0131452 | Cobltenz, Jr. | Jul. 17, 2003 |
| U.S. Pat. 6681530 | Givens | Jan. 27, 2004 |
| U.S. Pat. 5675939 | Hickner | Oct. 14, 1997 |
| U.S. Pat. 5333419 | Hickner | Aug. 2, 1994 |
| U.S. Pat. 5109641 | Halan | May 5, 1992 |
| U.S. Pat. 4391068 | Kosar | Jul. 5, 1983 |
| U.S. Des. Pat. D555,773 | Wallace | Nov. 20, 2007 |

The teachings of each of the above-listed citations (which does not itself incorporate essential material by reference) are herein incorporated by reference. None of the above inventions and patents, taken either singularly or in combination, is seen to describe the instant invention as claimed.

While the foregoing body of art indicates it to be well known to have kick flashing apparatus, the art described above does not teach or suggest an contiguous inverted shelf kick flash apparatus which has the following combination of desirable features: (1) an inverted “kicker” shelf which prevents “wicking” of water to the siding material; (2) inverted “kicker” shelf allows normal reveal of a roofing shingle (3) length which provides adequate coverage to the next piece of step flashing; (4) does not have vertical stand-up at the gutter end of kick flashing to cut siding around; (5) does not have vertical stand-up at the gutter end of kick flashing which causes the buildup of leaves and debris; (6) allows for uniformity in kick flashing; (7) has universality in that one flashing works for both left and right applications; (8) is plug and play in that no on-site modifications are needed; (9) is one contiguous unit; (10) requires no affixing other than nailing to the transition wall, is just put down and roof lain over it; (11) pressed out of one piece of sheet metal and folded as opposed to soldering; and (12) no soldering in the joint break, among others.

### SUMMARY AND ADVANTAGES

An contiguous inverted shelf kick flashing apparatus is provided and includes a sheet of metal folded at a first angle along a bend joint to form a first sheet face and a second sheet face, and an inverted shelf bent inward at an second angle from the bend joint at a point of shelf inversion, along an inverted shelf edge, having a first and second triangular faces at an third angle to each other. A contiguous inverted shelf kick flash apparatus, including a sheet of metal flashing including a first and second opposing edges, a first bend extending through a portion of said sheet from a first point on said first edge to a break point, said break point located along a straight line between said first point and a second point along said second edge, wherein said first bend defines first and second flange faces and an interior angle between said first and second flange faces, and a second bend in opposing orientation to said first bend, said second bend extending from said break point to said second point on said second edge, said second bend forming an inverted corner diverter.

The contiguous inverted shelf kick flash apparatus of the present invention presents numerous advantages, including: (1) an inverted “kicker” shelf which prevents “wicking” of water to the siding material; (2) inverted “kicker” shelf allows normal reveal of a roofing shingle (3) length which provides adequate coverage to the next piece of step flashing; (4) does not have vertical stand-up at the gutter end of kick flashing to cut siding around; (5) does not have vertical stand-up at the gutter end of kick flashing which causes the buildup of leaves and debris; (6) allows for uniformity in kick flashing; (7) has universality in that one flashing works for both left and right applications; (8) is plug and play in that no on-site modifications are needed; (9) is one contiguous unit; (10) requires no affixing other than nailing to the transition wall, is just put down and roof lain over it; (11) pressed out of one piece of sheet metal and folded as opposed to soldering; and (12) no soldering in the joint break, among others. Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an embodiment of a contiguous inverted shelf kick flash apparatus.

FIG. 2 shows another view of the embodiment of the kick flash apparatus shown in FIG. 1.

FIG. 3 shows another view of the embodiment of the kick flash apparatus shown in FIG. 1.

FIG. 4 shows an end view of the embodiment of the kick flash apparatus shown in FIG. 1.

FIG. 5 shows a view of the embodiment of the kick flash apparatus shown in FIG. 1 in use.

### REFERENCE NUMERALS IN DRAWINGS

Contiguous Inverted Shelf Kick Flash Apparatus
12 First Sheet Face
14 Second Sheet Face
16 Inverted Shelf
18 Point of Shelf Inversion
20 Inverted Shelf Edge
22 Bend Joint
24 First inverted shelf bend joint
26 Second inverted shelf bend joint
28 First triangular face
30 Second triangular face
R Roof
S Shingle
G Gutter
W Siding

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

An contiguous inverted shelf kick flashing apparatus 10 is provided and includes a sheet of metal folded at a first angle along a bend joint to form a first sheet face and a second sheet face, and an inverted shelf bent inward at an second angle from the bend joint at a point of shelf inversion, along an inverted shelf edge, having a first and second triangular faces at an third angle to each other. A contiguous inverted shelf kick flash apparatus, including a sheet of metal flashing including a first and second opposing edges, a first bend extending through a portion of said sheet from a first point on said first edge to a break point, said break point located along a straight line between said first point and a second point along said second edge, wherein said first bend defines first and second flange faces and an interior angle between said first and second flange faces, and a second bend in opposing orientation to said first bend, said second bend extending from said break point to said second point on said second edge, said second bend forming an inverted corner diverter.

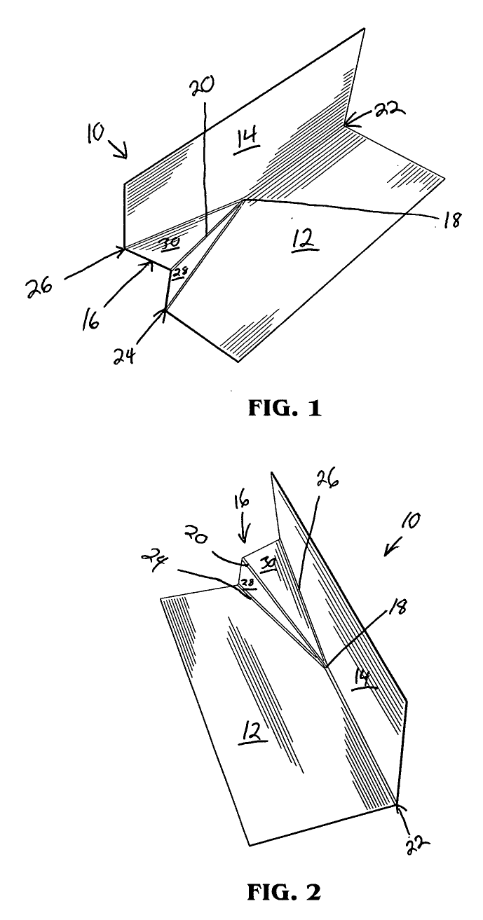

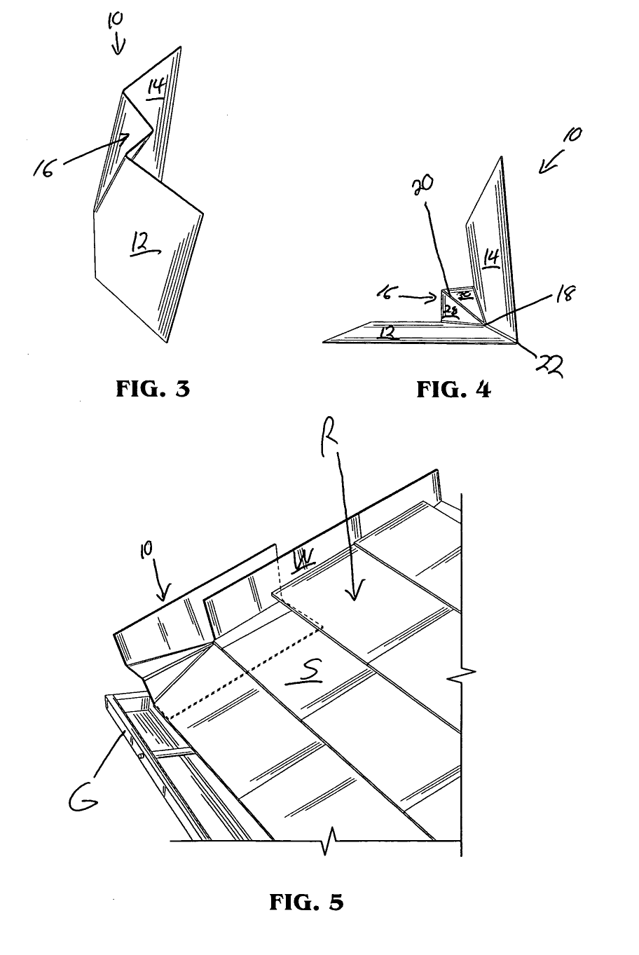

As shown in FIGS. 1-5, a contiguous inverted shelf kick flash apparatus 10 includes a first sheet face 12 and a second sheet face 14 at an angle to each other at a bend joint 22, with an inverted shelf 16 portion of the joint extending bending inwardly along an inverted shelf edge 20 forming an inverted corner diverter. Inverted shelf 16 is bent from second sheet face 14 along second inverted shelf bend joint 26 and from first sheet face 12 along first inverted shelf bend joint 24.

Preferably the contiguous inverted shelf kick flash apparatus 10 is pressed out of one 12″ long by 10″ wide rectangular sheet of galvanized sheet metal. It is folded, as opposed to soldered, along the bend joint 22 to form two rectangular sheets, the first face 12 and second face 14. The inverted shelf 16 is bent inward from the bend joint 22 from the starting at the point of shelf inversion 18 along the inverted shelf edge 20. A portion of the bend joint 22 is triangularly inverted into an inverted shelf 16 into the space defined by the planes of the first sheet face 12 and second sheet face 14 forming an inverted corner diverter having first and second triangular faces 28, 30 shaping a two sided pyramidal bend with an open base and its apex at the point of shelf inversion 18 along the bend joint 22, an inverted shelf edge 20 extending form the bend joint 22 at an obtuse angle.

Preferably, first sheet face 12 and second sheet face 14 are at a right angle +/−10 degrees to each other. Preferably, first and second triangular faces 28, 30 are at a right angle +/−10 degrees to each other. Preferably, first triangular face 28 and first sheet face 12 are at a right angle +/−10 degrees to each other. Preferably, second triangular face 30 and second sheet face 14 are at a right angle +/−10 degrees to each other.

Preferably, the inversion shelf measures 1¾″ at its furthers point from the first face, which allows siding to cover ¼″ above the surface of the shelf to prevent any “wicking” of the water to the siding material. The inverted shelf 16 preferably measures 5″ long allowing normal reveal of roofing shingle.

As shown in FIG. 5, the contiguous inverted shelf kick flash apparatus 10 installs on the roof R with no need for affixing. It is laid down up against a wall W on top of start shingles S, with the apparatus 10 hanging over the sheathing edge into the gutter G, preferably ½″. The apparatus 10 is then nailed on the second face 14 which abuts the wall W.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A contiguous inverted shelf kick flashing apparatus, comprising:
a sheet of metal folded at a first angle along a bend joint to form a first sheet face and a second sheet face; and
an inverted shelf bent inward at a second angle from the bend joint at a point of shelf inversion, along an inverted shelf edge, having a first and second triangular faces at an third angle to each other.

2. The apparatus of claims 1, wherein said metal is galvanized sheet metal.

3. The apparatus of claims 1, wherein said sheet of metal is 5″×12″.

4. The apparatus of claims 1, wherein said inverted shelf edge is 1¾″ from the first face at its furthest point.

5. The apparatus of claim 1, wherein said first angle is a right angle +/−10 degrees.

6. The apparatus of claim 1, wherein said second angle is an obtuse angle.

7. The apparatus of claim 1, where said third angle is a right angle +/−10 degrees to each other.

8. The apparatus of claim 1, wherein said first triangular face and said first sheet face are at a right angle +/−10 degrees to each other.

9. The apparatus of claim 1, wherein said second triangular face and said second sheet face are at a right angle +/−10 degrees to each other.

10. A method for making a contiguous inverted shelf kick flash apparatus, comprising the steps of:
providing a rectangular sheet of metal flashing, said sheet including first and second opposing parallel ends;
forming a first and second perpendicular flange faces by folding said sheet along an axis of said sheet, said fold extending from a first point along said first end to a second point along said second end, to form a right angle bend; and
forming an inverted corner kicker at said second point on said right angle bend by inverting said right angle bend at said second point, said kicker consisting of:
a first kicker face perpendicular to said first flange face; and
a second kicker face perpendicular to said second flange face.

11. A contiguous inverted shelf kick flash apparatus, comprising:
a sheet of metal flashing including a first and second opposing edges;
a first bend extending through a portion of said sheet from a first point on said first edge to a break point, said break point located along a straight line between said first point and a second point along said second edge, wherein said first bend defines first and second flange faces and an interior angle between said first and second flange faces; and
a second bend in opposing orientation to said first bend, said second bend extending from said break point to said second point on said second edge, said second bend forming an inverted corner diverter.

12. The apparatus of claim 7, wherein said first bend is a right angle.
